(19) United States
(12) Patent Application Publication
(10) Pub. No.: US 2025/0045642 A1
(43) Pub. Date: Feb. 6, 2025

(54) MODEL SELECTION USING FEATURE HEALTH SCORES WITH UNRELIABLE SENSORS

(71) Applicant: Dell Products L.P., Round Rock, TX (US)

(72) Inventors: Paulo Abelha Ferreira, Rio de Janeiro (BR); Pablo Nascimento Da Silva, Niterói (BR); Vinicius Michel Gottin, Rio de Janeiro (BR)

(73) Assignee: Dell Products L.P., Round Rock, TX (US)

(21) Appl. No.: 18/230,501

(22) Filed: Aug. 4, 2023

(51) Int. Cl. G06N 20/20; G06F 17/16

(52) U.S. Cl. CPC G06N 20/20; G06F 17/16

(57) ABSTRACT

Techniques are disclosed for model selection using feature health scores with unreliable sensors. One example method includes clustering health score vectors received from nodes operating in an environment, the health score vectors including feature health scores for sensors used by machine learning models; comparing a model score distribution for an ensemble of the models with model score distributions per cluster, to obtain a set of top K performing models for each cluster, upon receiving new data for prediction, identifying an associated health score vector for the data and using the top K performing models corresponding to the cluster for the associated health score vector to select the top K performing models; and deploying the clusters and model ensembles to the nodes.

### FIELD

Example embodiments generally relate to machine learning-based event detection. More particularly, at least some embodiments relate to systems, hardware, software, computer-readable media, and methods for event detection in an edge environment with multiple sensors.

### BACKGROUND

When objects operating in an environment are autonomous, and for other reasons, there is often a desire to detect events that may occur or are occurring in the environment. For example, it may be beneficial to detect a potential collision between two objects or detect when an object is turning in a dangerous manner. Detecting events allows remedial or corrective actions to be performed and may prevent adverse consequences.

When providing smart services, such as detecting events, the autonomy of autonomous objects operating in an environment impacts the ability to detect events. Unfortunately, the ability to successfully detect events in such an environment is often hampered by the fact that some of the data used to detect events may be compromised, noisy, fault, missing, or invalid. Unreliable data from these sources can adversely impact the ability to detect events in an environment.

### BRIEF SUMMARY

In one embodiment, a system includes at least one processing device including a processor coupled to a memory. The at least one processing device is configured to implement the following steps: clustering health score vectors received from nodes operating in an environment, the health score vectors including feature health scores for sensors used by machine learning models; comparing a model score distribution for an ensemble of the models with model score distributions per cluster, to obtain a set of top K performing models for each cluster; upon receiving new data for prediction, identifying an associated health score vector for the data and using the top K performing models corresponding to the cluster for the associated health score vector to select the top K performing models; and deploying the clusters and model ensembles to the nodes.

In some embodiments, the processor is further configured to implement causing the nodes to generate inferences using the deployed clusters and model ensembles to select a model among the top K performing models for generating the inferences. The model score distributions per cluster can be obtained using a process comprising: for each cluster, determining a set of model score vectors per cluster, the model score vectors containing model scores, and using the set of model vectors to construct the distributions of model scores per cluster. The model scores can be determined by generating a vector for each model, the vector including feature importance scores for each feature of a corresponding model and the feature health scores for each feature of each sensor used by the corresponding model. The feature importance scores can be arranged in a first matrix and the feature health scores can be arranged in a second matrix, where each vector is a dot product of a corresponding first matrix and a corresponding second matrix, and where the vector includes a model score for each of the models. The model score distributions can be constructed using distribution fitting. The model score distribution for the ensemble of the models can be compared with the model score distributions per cluster using a probability distance measure. The feature health scores can be collected according to a pre-determined period that is specified for each node. The health score vectors can be received at a near edge node configured to accumulate the health score vectors prior to transmission to a central node. The clusters and model ensembles can be reset periodically for re-clustering. The health score vectors can be clustered using unsupervised multi-dimensional clustering. The health score vectors can be clustered using supervised multi-dimensional clustering based on labels received from the nodes.

Other example embodiments include, without limitation, apparatus, systems, methods, and computer program products comprising processor-readable storage media.

Other aspects of the invention will be apparent from the following description and the appended claims.

### BRIEF DESCRIPTION OF THE SEVERAL VIEWS OF THE DRAWINGS

The foregoing summary, as well as the following detailed description of exemplary embodiments of the invention, will be better understood when read in conjunction with the appended drawings. For purposes of illustrating the invention, the drawings illustrate embodiments that are presently preferred. It will be appreciated, however, that the invention is not limited to the precise arrangements and instrumentalities shown.

In the drawings:

FIG. 1A discloses aspects of nodes operating in environments, in accordance with illustrative embodiments;

FIG. 1B discloses aspects of data generated at and collected from nodes in an environment, in accordance with illustrative embodiments;

FIG. 1C discloses aspects of training models to be deployed to nodes in an environment, in accordance with illustrative embodiments;

FIG. 2A discloses aspects of training multiple models, in accordance with illustrative embodiments;

FIG. 2B discloses aspects of determining feature importance, in accordance with illustrative embodiments;

FIG. 2C discloses aspects of feature health scores, in accordance with illustrative embodiments;

FIG. 3 discloses aspects of an architecture for selecting models from a model ensemble, in accordance with illustrative embodiments;

FIG. 4 discloses aspects of health score vector clustering, in accordance with illustrative embodiments;

FIG. 5 discloses aspects of collecting health score vectors at an edge node, in accordance with illustrative embodiments;

FIG. 6 discloses aspects of selecting a set of top K performing models per cluster, in accordance with illustrative embodiments;

FIG. 7 discloses aspects of selecting models from a model ensemble, in accordance with illustrative embodiments; and

FIG. 8 illustrates aspects of an example computing entity configured and operable to perform any of the disclosed methods, algorithms, processes, steps, and operations, in accordance with illustrative embodiments.

### DETAILED DESCRIPTION

Example embodiments generally relate to machine learning-based event detection. More particularly, at least some embodiments relate to systems, hardware, software, computer-readable media, and methods for event detection in an edge environment with multiple sensors.

Disclosed herein are techniques that address a technical problem of choosing the top K performing subset of models from a model ensemble for prediction on domains with faulty and unreliable sensors. The present model selection techniques leverage a multi-stage solution with the insight that, for certain feature health score situations, some models are significantly better than the model ensemble so those top K models should be used instead of the ensemble. Example embodiments provide a continuous adaptive solution for choosing the top K performing models for smart logistics at the edge with faulty and/or unreliable sensors.

### A. General Aspects of an Example Embodiment

### A.1. Introduction

Enterprises increasingly need solutions to the rising artificial intelligence and machine learning (AI/ML) and infrastructure needs of the edge. An important edge space is smart services for mobile edge devices, for instance, in the logistic space of warehouse management and factories, where multiple mobile devices can require decisions in near-real time. The data collected from these mobile devices' trajectories (e.g., at a customer's warehouse) can be leveraged into machine learning (ML) models to optimize operation, or to address dangerous circumstances, via object/event detection approaches. Providing smart services using the present model selection techniques can improve the autonomy of these mobile edge devices and add value for customers.

Example embodiments help provide event detection at the edge with multiple sensors. One such example would be a factory or a logistics warehouse with multiple mobile edge devices performing tasks and depending on a multitude of sensors to obtain features for constructing datasets for ML training and inference.

One technical problem is that a relevant number of these sensors might be faulty, malfunction, fail to respond, or simply be noisy. Therefore, one or more features constructed from these sensors might be lacking for event detection models leading to poor performance and thus incurring in high cost. Some existing model selection systems create a model ensemble with weighted application of model outputs based on features' health scores and importance.

However, it is not necessarily the case that the model ensemble would be a better choice than a subset of the models from the ensemble. That is, it might be possible to beat the ensemble with the insight that, for certain feature health score situations, some models are much better than the ensemble so the present model selection techniques leverage these top K performing models (sometimes referred to herein as “champion models”) instead of the ensemble.

Existing model selection techniques include a method that calculates a health score per feature and uses it to weigh or drop out one or more models from decision making. More concretely, each sensor generates one or more features and multiple models feed from a subset of features. The present model selection techniques address a technical problem that a relevant number of these sensors might be faulty, malfunction, fail to respond, or simply be noisy. Therefore, one or more features constructed from these sensors might be lacking for event detection models leading to poor performance and thus incurring in high cost. One approach would be to train models and only select the features for which all sensors are available. However, such a method is too hasty in removing features (and possibly model outputs) from prediction when a problematic sensor or a missing feature might not be of that much importance for the ensemble. Other existing model selection systems leverage a weighted application of model output based on feature importance. For each model, an array of pre-calculated feature importance is used (e.g., during training). The present model selection techniques leverage a reasonable method that can infer or identify whether a sensor is outputting noisy/ood data (e.g., using statistical measures). Then, for each feature, based on one or more sensors, existing model selection techniques compute the feature's health score and combine it with the feature importance to obtain an aggregate health score per model. These health scores can then be used to decide on weighing each model's outputs.

The present model selection techniques address the further challenge of choosing the top K performing subset of models from a model ensemble for prediction on domains with faulty and unreliable sensors.

The present model selection techniques leverage a two-stage solution with the insight that, for certain feature health score situations, some models are significantly better than the model ensemble so those top K models should be used instead of the ensemble. Example embodiments provide a continuous adaptive solution for choosing the top K performing models for smart logistics at the edge with faulty and/or unreliable sensors.

### A.2. Technical Problems

The present model selection techniques provide decision making based on ML models for mobile edge devices. Particularly, providing event detection at the edge with multiple sensors. One example would be a factory or a logistics warehouse with multiple mobile edge devices (e.g., forklifts, or robots) performing tasks and depending on a multitude of sensors to obtain features for constructing datasets for ML training and inference.

The overall challenge is that a relevant number of sensors might be faulty, malfunction, fail to respond, or simply be noisy. Therefore, one or more features constructed from these sensors might be lacking for event detection models leading to poor performance and thus incurring in high cost. One approach would be to train models and only select the features for which all sensors are available. However, such an approach is too hasty in removing features (and possibly model outputs) from prediction when a problematic sensor or a missing feature might not be of that much importance for the ensemble.

One particular extra challenge tackled by the present model selection techniques is choosing the top K performing subset of models from a model ensemble for prediction on domains with faulty and unreliable sensors. This technical problem benefits from being able to classify and select what subset of models would beat their ensembles. It is further desirable for example embodiments to operate in a continuous manner, thus benefitting from a mechanism to ensure the present model selection techniques are not biased towards always selecting the same models.

### A.3. Technical Advantages

The present model selection solution addresses the challenge of choosing the top K performing subset of models from a model ensemble for prediction in domains with faulty and unreliable sensors.

Example embodiments extend existing model selection systems to add a more refined choice of model ensemble per health score vector (HSV) at each edge node. This choice involves being able to have clusters for HSVs that can then be associated with model sub-ensembles that work better for those HSVs.

### B. Context for an Example Embodiment

### B.1. Overview

One scenario addressed by example embodiments is providing smart services for mobile edge devices, for example, in the logistic space of warehouse management and safety, multiple mobile devices can benefit from decisions in near-real time (e.g., forklift trucks). The data collected from these mobile devices' trajectories (e.g., at a customer's warehouse) can be leveraged into ML models to optimize operation, or to address dangerous circumstances, via object/event detection approaches. Example embodiments provide smart services to improve the autonomy of these mobile edge devices and add value to customers.

Some existing systems leverage two ML and algorithmic models: one capable of detecting dangerous events and another for classifying typical trajectories. Combined, these models can be deployed to mobile edge devices to detect dangerous events form trajectory data.

The sections below provide additional context for example embodiments. This context can involve sensor data collection, model training, and inference at the edge.

### B.4. Environment

Logistics operations in an environment, including environments that include autonomous objects such as robots or forklifts, are often performed using data generated in the environment. For example, sensors associated with an object operating in the environment may generate data such as position data, inertial data, video data, or the like, although similar data may also come from other objects or sources in the environment. This data can be provided as input to a machine learning model, which generates inferences therefrom. More specifically, features may be extracted from the sensor or other data and input to the machine learning model.

For example, a model may be trained to detect dangerous cornering events (or other events) based on trajectory data such as data from inertial sensors, proximity sensors, position sensors, or the like. The output of the model may be a probability that a dangerous cornering event is occurring. If the model determines that a dangerous cornering event is occurring, the output of the model allows the object to take corrective actions such as slowing down or changing its trajectory. More specifically, an autoencoder may be trained with normative cornering data. When a reconstruction error of the autoencoder is greater than a threshold, a non-normative event, such as a dangerous cornering event, is detected.

More generally, a factory, warehouse, or other environment may include multiple mobile objects that may operate autonomously. The logistics and other tasks performed by or for these objects may depend on data from multiple sensors. Data from the sensors may also be used to construct datasets that can be used for machine learning training and inference.

However, some of these sensors (or data sources) may malfunction, be nonresponsive, be faulty, or be noisy. As a result, any features generated or constructed from the data generated by or collected from these sensors may lead to poor performance (e.g., poor model performance) and may incur high costs. Performing an action based on faulty data, more example, may ironically cause an adverse consequence that would otherwise have been avoided.

As a result, it is useful to have data or features that are valid and useful. Existing model selection systems may generate scores on a per-feature basis. Further, different models may be trained using different subsets of the available features. This allows models to be selected based on the scores of the features used as inputs to the models. More specifically, scoring the features allows the models to be scored as well and accordingly, model selection systems can select the best scoring models for deployment to nodes in the environment.

Advantageously, unreliable sensors and/or features can be detected, identified, and/or excluded from event detection. This allows models to be intelligently selected or weighed. The inferences of the models can be weighed, in one example, and the trust in the inference can be treated accordingly. For example, decisions based on less-trusted models may require a higher threshold level or probability output. Advantageously, features that are faulty or unavailable can be excluded from model training in some instances. If the feature later becomes reliable, the models can be retrained.

Existing model selection systems may train multiple models, which may have the same and/or different purposes, with different sets of features. For example, each feature may be associated with a health score and/or an importance score. The health score and the importance score can be combined into an aggregated score for each feature. The aggregated scores of the features can be combined to generate a model score.

The model score may be used to select which models should be deployed. For example, two models may both perform the same event detection, while relying on different features or different sets of features. The model deployed may be the model with the best aggregated feature scores or the best model score. This allows for robust event detection in dynamic environments with unreliable sensors.

Some model selection systems also offer event detection with multiple sensors where a number of these sensors may be unreliable (e.g., faulty, malfunction, fail to respond, or noisy).

Objects operating in an environment may include mobile, movable, and/or stationary objects. These objects may include hardware such as processors, memory, networking hardware, and the like. The type of hardware associated with a specific object may depend on the object. A pallet, for example, may only include an RFID tag that can be read by an RFID reader. The hardware, and any agents or models or other software operating thereon, may be referred to as a node. Reference to a node may refer to the hardware and/or the object as a whole.

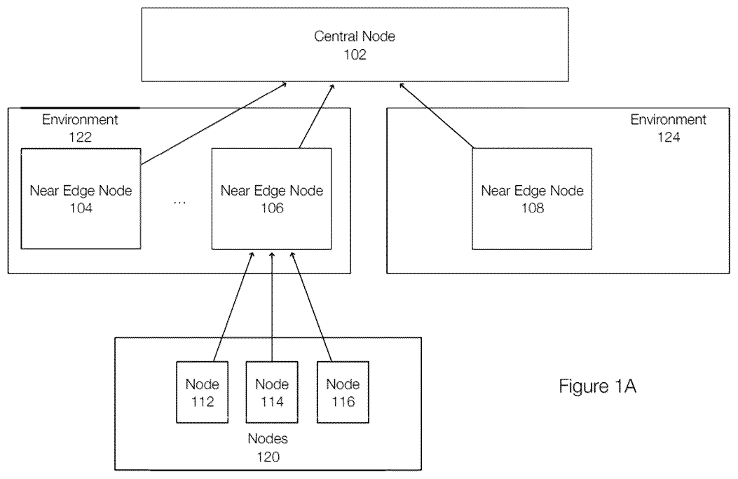

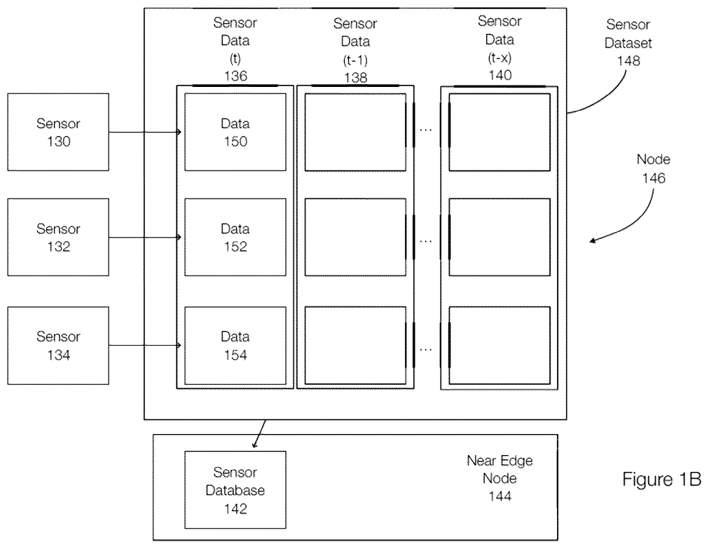

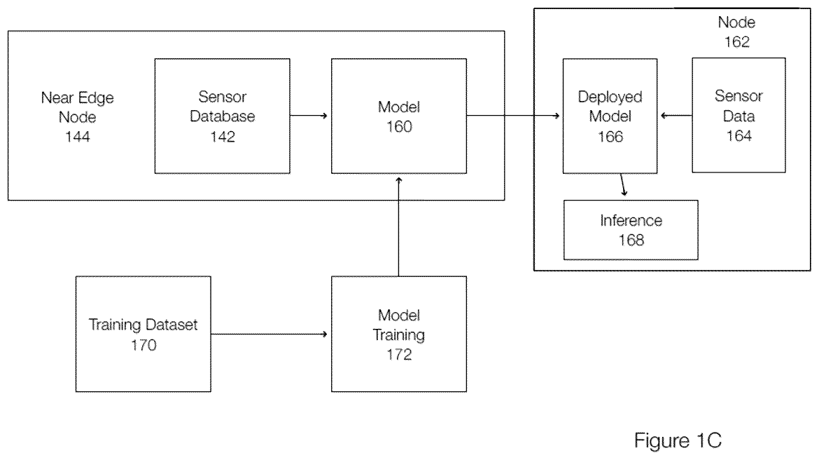

FIG. 1A discloses aspects of environments in which selected models are trained and deployed to nodes in the environment, in accordance with illustrative embodiments. FIG. 1A illustrates an environment 122 and an environment 124. The environments 122 and 124 may be warehouses, factories, stores, or the like. The environments 122 and 124 may be associated with the same entity or with different entities. The environment 122 is associated with at least one near edge-node, represented by a near edge node 104 and a near edge node 106. The environment 124 includes near edge node 108.

Each of the near edge nodes may be associated with a group or set of nodes (objects in the environment). The near edge node 106 is associated with nodes 120, which includes the nodes 112, 114, and 116. These nodes 120 are examples of far-edge nodes. Generally, the near edge node 106 includes more powerful computing resources than the nodes 120.

A central node 102 may also be included or available. The central node 102 may operate in the cloud and may communicate with multiple near edge nodes associated with multiple environments. However, the central node 102 may not be necessary. Thus, the near edge node 106 may be a central node from the perspective of the nodes 120. Alternatively, the nodes 120 may communicate directly with the central node 102.

### B.2. Sensor Data Collection

FIG. 1B discloses aspects of data generated at or collected from a node, in accordance with illustrative embodiments. The node 146 (an example of the nodes 120) may include or be associated with sensors 130, 132, 134. The sensors 130, 132, 134 may include inertial sensors, position sensors, load sensors, direction sensors, proximity sensors, or the like or combinations thereof. These sensors 130, 132, 134 generate, respectively, data 150, 152, 154.

In one example, data is generated and collected as collections 136, 138, 140. Thus, the collection 136 is a set of sensor data generated or collected at time t. The sensor data 138 was collected at time t-1 and the sensor data 140 was collected at time t-x. The sensor dataset 148, which includes one or more collections, may be stored at least temporarily at the node 146 and is transmitted to the near edge node 144 and stored in a sensor database 142. The sensor dataset 148 may be limited to x collections in some embodiments. The sensor database 142 may store sensor data from multiple nodes in an environment. The sensor database 142 may store data for longer periods of time.

For example, sensor data (e.g., inertial, proximity, position) related to an object's trajectory can be used to predict a dangerous cornering event or a potential collision when input to a trained machine learning model. In one example, if each collection corresponds to a position, multiple collections can be used as input to a model, which may then generate an inference as to whether the trajectory is a dangerous cornering event.

### B.3. Model Training and Inference at the Edge

FIG. 1C discloses aspects of model training and model deployment, in accordance with illustrative embodiments. In FIG. 1C, a training dataset 170 is used for model training 172. Thus, the model 160 is the result of model training 172 based on the training dataset 170. The training dataset 170 may be generated from historical sensor data, which may be stored in the sensor database. The model 160 can be deployed to the near edge node 144 and generate inferences from sensor data received from nodes in the environment. The model 160 may be deployed to the node 162 as the deployed model 162 and generate an inference 168 based on sensor data 164 generated at the node 162.

The model 160 and the deployed model 166 may generate the same inferences but use different data. The model 160 may have the benefit of generating inferences based on data from multiple nodes while the deployed model 166 only uses data from the node 162. In one example, the model 160 and the model 166 are the same.

The collection of the sensor data 164 at the node 162 may be triggered periodically, by a change in values (e.g., when acceleration or deceleration is detected), periodically, and/or for other reasons. The collected data may be input to the deployed model 166 to generate an inference 168. In some examples, the sensor data 164 is processed to extract features and the features are input to the deployed model 166. Features extracted from the sensor database 142 may be input to the model 160.

As described below, the features used as input to the models may be scored. The feature scores and/or model scores, which are based on the feature scores, may be used to select which models are deployed, determine when models are retrained, replaced, recalled, or the like.

### B.4. Multi-Model Event Detection

As mentioned, existing model selection systems include a method that calculates health scores, one per sensor feature, and uses them to weigh or drop out one or more models from decision making. More concretely, each sensor generates one or more features and multiple models feed from subset of features. As discussed, the present model selection techniques address the challenge that a relevant number of these sensors might be faulty, malfunction, fail to respond, or simply be noisy. Therefore, one or more features constructed from these sensors might be lacking for event detection models leading to poor performance and thus incurring in high cost

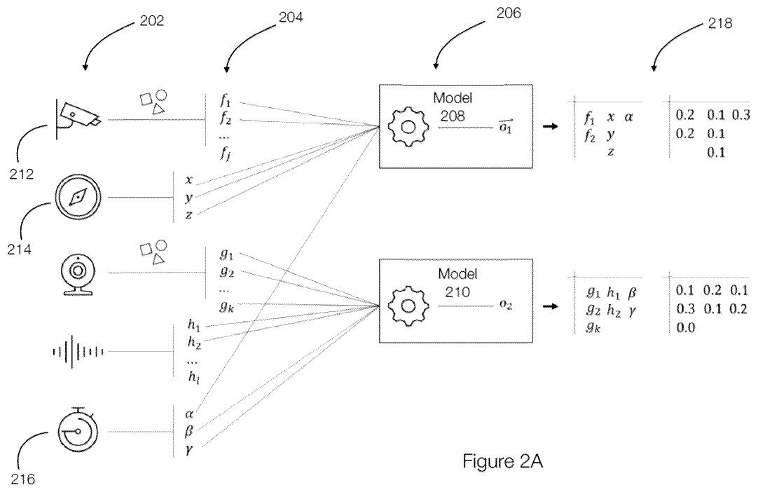

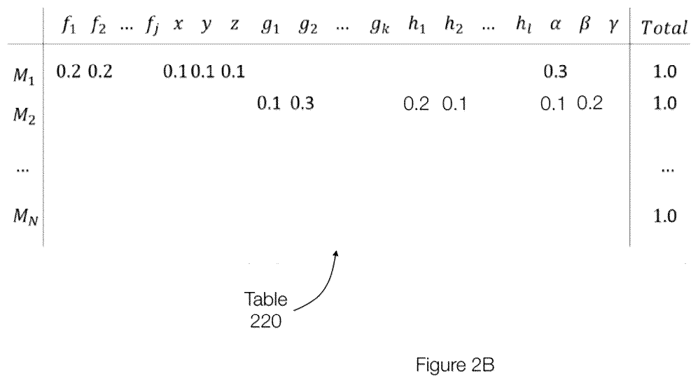

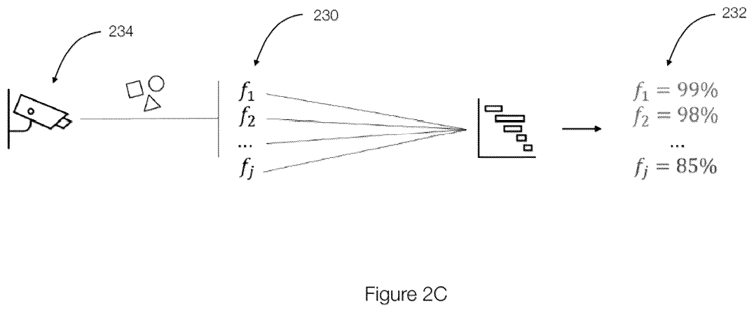

Although FIG. 1A depicts the training and deployment of a single model, example embodiments of the present model selection techniques address the deployment of several models, each one receiving as inputs a subset of all sensors' features and outputting different event detections (e.g., dangerous cornering, collision, and the like). FIG. 2A shows aspects of a schematic of a multi-sensor, multi-feature, multi-model scenario as an example highlighting technical problems solved by the present model selection solution:
Multiple sensors:
   Of different modalities;
   With multiple features per sensor;
   With similar modality, but different types/circumstances (e.g., cameras of different types; fixed or moving embedded on an AMR etc.)
Multiple models;
   With multiple sensors as input
   With only subset of features per each input sensor
   With different outputs (e.g., dangerous cornering, collision etc.).

One approach would be to train models and only select the features for which all sensors are available. However, this approach is too hasty in removing features (and possibly model outputs) from prediction when a problematic sensor or a missing feature might not be of that much importance for the ensemble.

Instead, existing model selection systems use a weighted application of model output based on feature importance. For each model, an array contains pre-calculated feature importance (e.g., during training). A reasonable method can be used to determine whether a sensor is outputting noisy/o.o.d. data (e.g., statistical measure). Then, for each feature, based on one or more sensors, the existing system computes the feature's health score and combines it with the feature importance to obtain an aggregate health score per model. These health scores can be used to decide on dropping or weighing each model's outputs.

Accordingly, some existing model selection systems provide event detection in dynamic environments with unreliable sensors.

### B.5. Feature Importance

FIG. 2A illustrates sensors 202 (e.g., camera, compass, microphone, inertial sensor) and features 204 that are extracted from the data generated by the sensors 202. The sensors 202 may include sensors with different modalities, with multiple features per sensor, with similar modalities but of different type, or the like. For example, the sensors 202 may include fixed cameras, moving cameras, embedded cameras, or the like.

FIG. 2A also illustrates multiple models 206, such as the model 208 and the model 210. The models 206 may receive features or data from multiple sensors as input. Further, the models 206 may receive one or more features from one or more sensors. As illustrated in FIG. 2A, the model 208 receives two features from the sensor 212, all features from the sensor 214, and one feature from the sensor 216. Because the models 208 and 210 have different features as inputs, the outputs or functions of the models 206 may be different. The model 208 may detect potential collision events while the model 210 may detect dangerous cornering events.

When the model 208 is trained, feature importance scores 218 for each of the models 206 is determined. This may be performed in relation to a validation dataset that is gathered separately from a training dataset.

For example, a feature importance score is generated for each of the features input to the model 208. The importance scores 218 sum to 1.0 in one embodiment for each model as the importance scores are normalized. The model 210 receives 7 features as input and feature importance scores are generated for each of these features.

FIG. 2B discloses aspects of a matrix for storing feature importance scores for each of the models, in accordance with illustrative embodiments. The table 220 reflects the feature importance scores for a set of models (e.g., M₁, M₂, . . . , M_{N}). The table 220 also illustrates which features are input to which of the models 206. As illustrated in the table 220, each of the models may receive a different subset of all possible features. In this example, the features received by models M₁ and M₂ include only one common feature.

In this example, each model has importance scores only for its corresponding input features. The feature importance scores of the feature a, for example, differ for model M, (0.3) and M₂ (0.1). Feature importance can be determined in different manners and normalized. Further, existing model selection systems may support different model types including neural network models, ensemble models, probabilistic models, or the like. When the input to the models are features, feature importance can be determined. In other words, the features can be ranked in terms of importance.

### B.6. Feature Health Score

Existing model selection systems may also determine a feature health score for each feature. Some sensors, for example, may be capable of outputting a health score for each feature. For sensors that are not able to output a feature health score, a statistical analysis can be performed on the output of the sensor to identify deviations from normal behavior, which can be converted to a feature health score. This behavior can be taken from technical expectations over values provided by an acceptable entity or inferred from behavior.

FIG. 2C discloses aspects of feature health scores, in accordance with illustrative embodiments. FIG. 2C illustrates features 230 of a sensor 234 and corresponding health scores 232. Each of the features 230 may be given a health score separately and independently. If a feature for the sensor 234 is performing poorly, the feature may be excluded from participation in model training/inference even if the feature is an important feature for one or more models. For example, the feature f, in FIG. 2C may be below a threshold score of 90% and be excluded from consideration by relevant models. This may avoid situations where a low health score adversely impacts model outputs. The health scores 232 may be updated periodically or for other reasons and reconsidered.

As described, the feature importance scores and the feature health scores can be combined into an aggregated score. The combination can be performed in various manners and may be weighted. For example, the health score may have a greater weight in the aggregated score. The aggregated score may be generated in different manners.

### B.7. Model Selection

The aggregated scores of the features can be used to perform model selection. In other words, when the near edge node can select from among multiple models, the model selected and deployed may depend on the aggregated score of each of the model's features.

In one example, the importance scores and health scores are combined into a single vector for each of the models. For example, the importance scores may be represented by a matrix of feature importance scores: F∈R^{n×f}.

The feature health scores may be represented by a matrix of feature health scores: H E R^{f×1}. These matrices can be multiplied to arrive at a vector: \vec{m}∈R^{n×1}, with one score per model. In this example, n is the number of models and f is the number of features (from all sensors). This results in a model score of:

\vec{m}=F·H

Once the model score vector is determined, models can be selected based on a threshold basis or a ranking basis. The threshold can be set by an administrator or other person/entity or by default. The performance of each model may also be measured on a validation data set. This may be used to determine the threshold for the next model selection operation. A model selection operation can be performed periodically or can be triggered based on the overall model performance, the addition of new sensors, or any event that may alter the data streams, when a now model, or the like. In one example, for a particular type of event detected by several models, the model selected and deployed is the model with the best model score. However, this may be adapted in some instances to account for models that may not have access to their most important feature. Multiple factors may be used to select a model for deployment.

### C. Detailed Discussion of an Example Embodiment

### C.1. Architecture

The present model selection techniques address the extra challenge of choosing the top K performing subset of models from a model ensemble for prediction in domains with faulty and unreliable sensors. As mentioned, one challenge is to choose the top K performing subset of models from a given ensemble.

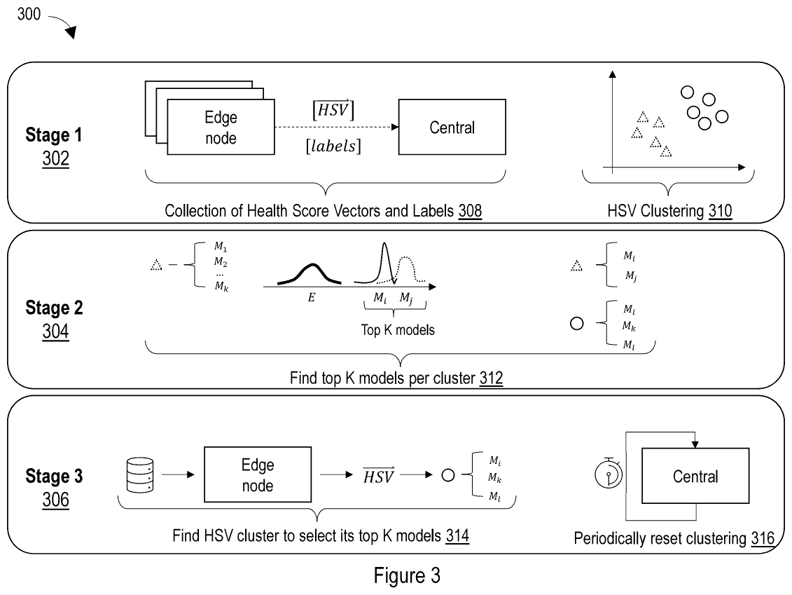

FIG. 3 discloses aspects of an architecture 300 for model selection, in accordance with illustrative embodiments. In example embodiments, the architecture can be a three-stage solution, as described below:
1. Stage 1 (302): HSV Clustering
   a. Collection of Health Score Vectors (HSVs) from each near edge and its models, along with collection of labels 308
   b. After sufficient collection, the HSVs can be clustered 310, for example at a central node
2. Stage 2 (304): Top K performing model sorting
   a. For each HSV cluster, calculate each model's and the ensemble's validation scores
   b. Then, for each HSV cluster, a distribution of scores is available for each model and for the ensemble
   c. Models with a sufficiently superior distance from the ensemble (e.g., probability distance measure) can be selected as top K performing models 312
3. Stage 3 (306): Sub-ensemble selection
   a. As new data arrive, an associated HSV can be used to find the corresponding cluster and its top K performing models 314
   b. Periodically reset the clustering process (Stage 1 (302)), thus also possibly re-sorting the champion models 316. The clustering process can be periodically reset, so as to mitigate past bias and determine a decay function where the probability distance measure decision can be softened, so as to select ever more models.

### C.2. Health Score Vector Clustering

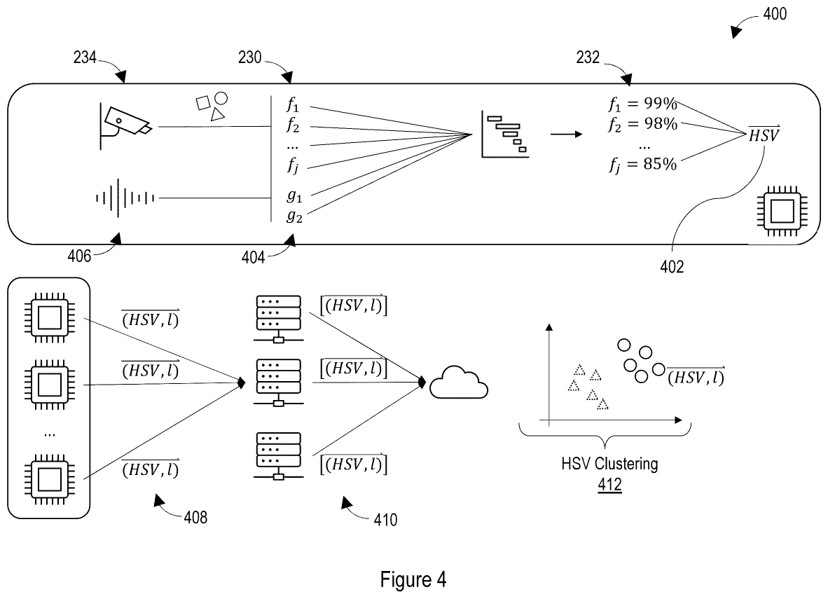

FIG. 4 discloses aspects of health score vector (HSV) clustering 412, in accordance with illustrative embodiments.

In this stage, example embodiments collect and transmit 408 health score vectors and data labels from the edge nodes to a central node. In some embodiments, the collection of feature health scores can use a method such as the one described in Section B.6. For example, the HSVs have one entry per feature 230, 404 per sensor 234, 406. The collection 408 can be done periodically with a pre-specified period that is set for each edge node. These HSVs can then be accumulated 410 in a near edge node or directly transmitted to the central node. The specific choice on the period and accumulation of vector prior to transmission can be determined according to the particular domain. For example, if a near edge node is available to accumulate many HSV prior to sending, this accumulation might be more cost effective than opening a transmission channel for each HSV from an edge node.

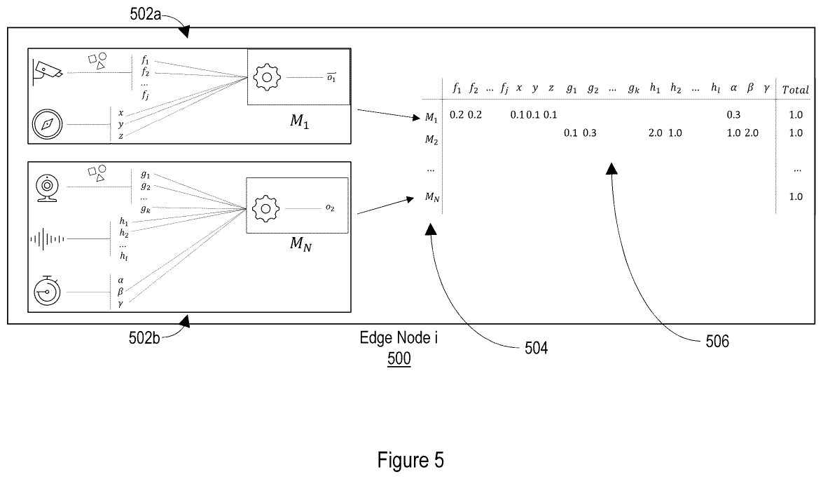

FIG. 5 shows aspects of collecting HSVs per model at an edge node 500, in accordance with example embodiments.

As mentioned, in example embodiments each HSV 502a, 502b has associated with it a model and (optionally) a label. In some embodiments, the HSV can be row vectors 504 as shown in the matrix 506. FIG. 5 shows a matrix for a given collection and, it is appreciated that an edge node is periodically collecting these HSVs. Accordingly, for a certain time period there might be numerous HSVs per model. Example embodiments of the present model selection techniques are configured to track the association between HSV, model, and label.

With reference to FIG. 4, if labels are available at the edge nodes then example embodiments also collect 408 those labels for performing the HSV clustering 412, which can be supervised clustering of the HSV vectors. In other embodiments, labels might be available but only at the near edge node. In this case, example embodiments transmit the HSVs from each edge node to the near edge node, along with a timestamp to associate the HSVs with labels that are to be computed at the near edge. In still other embodiments, if labels are unavailable, then the HSV clustering can be performed in an unsupervised manner using any available techniques for multi-dimensional clustering, without departing from the scope of embodiments discussed herein.

For the HSV clustering 412, as discussed example embodiments might perform supervised or unsupervised clustering. In both cases, it is possible to know a priori the number of clusters to use. That is, the domain in which the present model selection techniques are operating might inform a specific number of HSV clusters. In other embodiments, if the number of clusters is not known beforehand, any techniques to choose well-fit clusters to the corresponding data can be used without departing from the scope of the embodiments described herein. For non-functioning features of sensors, example embodiments can use a default value, such as 0% to indicate a malfunctioning status.

In example embodiments, the present HSV clustering results in a clustering model configured to map a new HSV to one of the clusters and also configured to retrieve all models associated with the HSVs at each cluster. If there are clusters with less than a pre-determined number of HSVs then that cluster can be disregarded and those HSVs ignored. In short, each cluster defines a list and accordingly a set of models that are associated with the list.

### C.3. Top K Performing Models Per Cluster

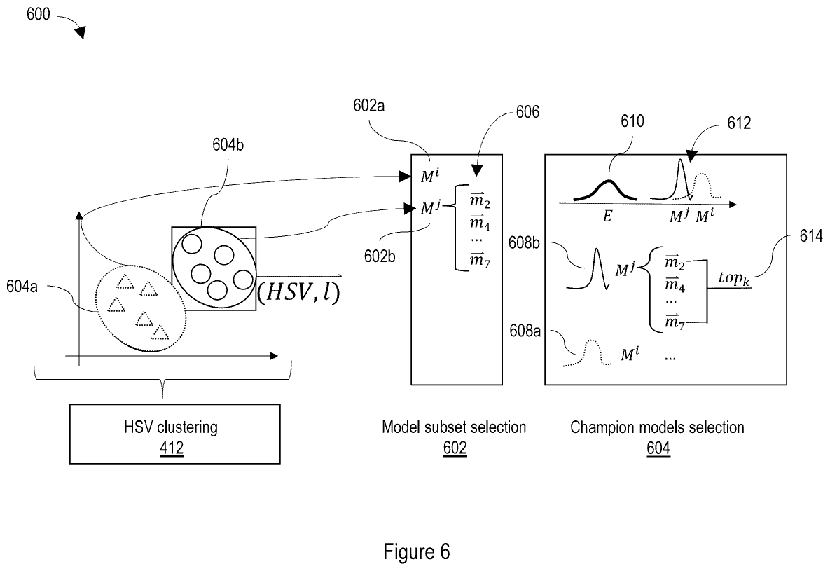

FIG. 6 discloses aspects of selecting a set of top K performing models, in accordance with illustrative embodiments.

In example embodiments, finding a set of top K performing model subsets per cluster starts with the central node collecting all the HSVs and (optionally) labels and performing clustering 412, as discussed in section C.2. Then, for each cluster found 604a, 604b, the present model selection techniques use the HSVs to build a matrix such as the example matrix discussed in section B.5. Some embodiments can then use a method such as the example discussed in section B.7. to arrive at a set M 602a, 602b of model vectors \vec{m} 606 per cluster. For example, FIG. 6 shows a set Mⁱ 602a of model vectors for the cluster 604a, and a set M^{j} 602b of model vectors for the cluster 604b. The set M^{j} includes the model vectors \vec{m} 606 \vec{m}₂, \vec{m}₄, . . . , \vec{m}₇.

After performing the calculation of model score vectors 602a, 602b for each cluster 604a, 604b, example embodiments construct distributions of model scores 608a, 608b per cluster. In one embodiment, the distribution construction uses distribution fitting. In another embodiment, the distribution construction uses domain expertise, for example expertise on the better distribution family to use, such as including hyper-parameters. Ultimately, the present model selection techniques result in the same family of distributions being fitted to the available model score vectors. In example embodiments, after calculating the distribution for each MSV, the present model selection solution also calculates the distribution for the ensemble of models 610 (e.g., for all available models).

At the conclusion of stage 2, example embodiments arrive at one distribution including all models (e.g., the ensemble distribution 610) and having one distribution per cluster 608a, 608b. FIG. 6 discloses aspects of obtaining the distributions from each cluster and then comparing the distributions to the ensemble 612, in accordance with illustrative embodiments.

This comparison 612 allows example embodiments to determine the cluster with top best performing model score (e.g., Mᵢ and Mⱼ 608a, 608b). In some embodiments, the present model selection techniques compare these distributions. For example, a probability distance measure can be used. Then, example embodiments select those clusters whose distributions are further away from the ensemble (e.g., to the higher side). In other words, clusters can be selected that have a higher distribution score. Example embodiments then sum the clusters' model vectors and then select the top K performing models to be the models under consideration at the edge. In some embodiments, clusters that do not perform well enough to be sufficiently to the right of the ensemble are associated with the model ensemble. That is, in Stage 3, when selecting the best ensemble for a given HSV, if the HSV maps to a low performing cluster, that HSV is associated with the complete ensemble.

### C.4. Edge Node Inference

In example embodiments, once the clusters and cluster model ensembles are defined, for example at the central node, the present model selection techniques communicate the clusters and model ensembles to the edge nodes. It is appreciated that high transmission costs do not need to be incurred, since some embodiments only communicate the clustering model (e.g., a function to find a cluster from an HSV) and the indexes of the top K performing models per cluster.

In example embodiments, as new HSV data arrive at the edge node, the node can map that data using the clustering model to arrive at the recommended model ensemble to use for a given period. As mentioned, if during the mapping a given HSV falls too far outside a given cluster, the HSV can be assigned to the model ensemble.

In some embodiments, the present model selection techniques provide a process for determining when to re-cluster the ensembles for the top K performing models. For example, the re-clustering can be after a pre-determined period of time, after model drift, or after poor model performance (as received from a large number of edge nodes by the central node or Near Edge). Once the need for a new clustering is identified, example embodiments return to Stage 1 by causing the central node to communicate this need to the participant edge nodes.

### D. Example Methods

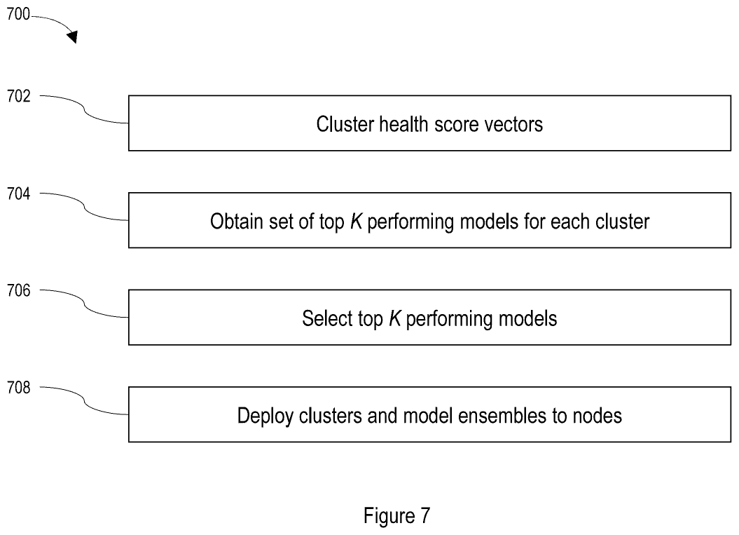

FIG. 7 illustrates aspects of selecting models from a model ensemble, in accordance with illustrative embodiments.

In example embodiments, a method 700 includes clustering health score vectors received from nodes operating in an environment (step 702). The health score vectors can include feature health scores for sensors used by machine learning models. In some embodiments, the feature health scores can be collected according to a pre-determined period that is specified for each node. The health score vectors can be received at a near edge node configured to accumulate the health score vectors prior to transmission to a central node. The health score vectors can be clustered using unsupervised multi-dimensional clustering. The health score vectors can be clustered using supervised multi-dimensional clustering based on labels received from the nodes.

In example embodiments, the method 700 includes comparing a model score distribution for an ensemble of the models with model score distributions per cluster, to obtain a set of top K performing models for each cluster (step 704). In some embodiments, the model score distributions per cluster are obtained using processing comprising: for each cluster, determining a set of model score vectors per cluster. The model score vectors can contain model scores. The processing further comprises using the set of model vectors to construct the distributions of model scores per cluster. The model scores can be determined by generating a vector for each model. The vector can include feature importance scores for each feature of a corresponding model and the feature health scores for each feature of each sensor used by the corresponding model. The feature importance scores can be arranged in a first matrix and the feature health scores can be arranged in a second matrix, where each vector is a dot product of a corresponding first matrix and a corresponding second matrix, and where the vector includes a model score for each of the models. The model score distributions can be constructed using distribution fitting. The model score distribution for the ensemble of the models can be compared with the model score distributions per cluster using a probability distance measure.

In example embodiments, the method 700 includes, upon receiving new data for prediction, identifying an associated health score vector for the data and using the top K performing models corresponding to the cluster for the associated health score vector to select the top K performing models (step 706). In some embodiments, the clusters and model ensembles can be reset periodically for re-clustering.

In example embodiments, the method 700 includes deploying the clusters and model ensembles to the nodes (step 708).

In example embodiments, the method 700 further includes causing the nodes to generate inferences using the deployed clusters and model ensembles to select a model among the top K performing models for generating the inferences.

It is noted with respect to the disclosed methods, including the example methods of FIGS. 1A-7, and the disclosed algorithms, that any operation(s) of any of these methods and algorithms, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### E. Example Computing Devices and Associated Media

As mentioned, at least portions of the present model selection solution can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the present divergence threshold solution. For example, containers can be used to implement respective processing devices providing compute and/or storage services of a cloud-based system. Again, containers may be used in combination with other virtualization infrastructure such as virtual machines implemented using a hypervisor.

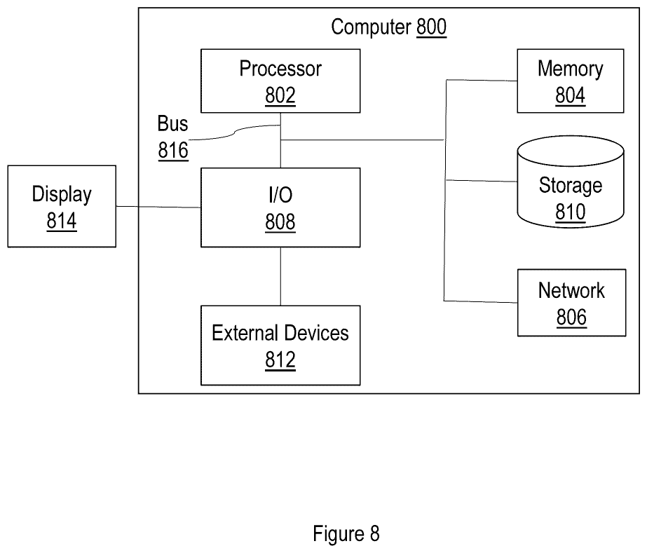

Illustrative embodiments of processing platforms will now be described in greater detail with reference to FIG. 8. Although described in the context of the present model selection solution, these platforms may also be used to implement at least portions of other information processing systems in other embodiments.

FIG. 8 shows an example computing entity 800, in accordance with example embodiments. The computer is shown in the form of a general-purpose computing device. Components of the computer may include, but are not limited to, one or more processors or processing units 802, a memory 804, a network interface 806, and a bus 816 that communicatively couples various system components including the system memory and the network interface to the processor.

The bus 816 represents one or more of any of several types of bus structures, including a memory bus or memory controller, a peripheral bus, an accelerated graphics port, and a processor or local bus using any of a variety of bus architectures. By way of non-limiting example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 800 typically includes a variety of computer-readable media. Such media may be any available media that is accessible by the computer system, and such media includes both volatile and non-volatile media, removable and non-removable media.

The memory 804 may include computer system readable media in the form of volatile memory, such as random-access memory (RAM) and/or cache memory. The computer system may further include other removable/non-removable, volatile/non-volatile computer system storage media. By way of example only, the storage system 810 may be provided for reading from and writing to a non-removable, non-volatile magnetic media (not shown and typically called a “hard drive”) in accordance with the present divergence threshold techniques. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media may be provided. In such instances, each may be connected to the bus 816 by one or more data media interfaces. As has been depicted and described above in connection with FIGS. 1A-7, the memory may include at least one computer program product having a set (e.g., at least one) of program modules that are configured to carry out the functions of the embodiments as described herein.

The computer 800 may also include a program/utility, having a set (at least one) of program modules, which may be stored in the memory 804 by way of non-limiting example, as well as an operating system, one or more application programs, other program modules, and program data. Each of the operating system, one or more application programs, other program modules, and program data or some combination thereof, may include an implementation of a networking environment. The program modules generally carry out the functions and/or methodologies of the embodiments as described herein.

The computer 800 may also communicate with one or more external devices 812 such as a keyboard, a pointing device, a display 814, etc.; one or more devices that enable a user to interact with the computer system; and/or any devices (e.g., network card, modem, etc.) that enable the computer system to communicate with one or more other computing devices. Such communication may occur via the Input/Output (I/O) interfaces 808. Still yet, the computer system may communicate with one or more networks such as a local area network (LAN), a general wide area network (WAN), and/or a public network (e.g., the Internet) via the network adapter 808. As depicted, the network adapter communicates with the other components of the computer system via the bus 816. It should be understood that although not shown, other hardware and/or software components could be used in conjunction with the computer system. Non-limiting examples include microcode, device drivers, redundant processing units, external disk drive arrays, RAID systems, tape drives, data archival storage systems, and the like.

### F. Conclusion

It is noted that embodiments of the invention, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

In the foregoing description of FIGS. 1A-8, any component described with regard to a figure, in various embodiments, may be equivalent to one or more like-named components described with regard to any other figure. For brevity, descriptions of these components have not been repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the disclosure, ordinal numbers (e.g., first, second, third, etc.) may have been used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

Throughout this disclosure, elements of figures may be labeled as “a” to “n”. As used herein, the aforementioned labeling means that the element may include any number of items and does not require that the element include the same number of elements as any other item labeled as “a” to “n.” For example, a data structure may include a first element labeled as “a” and a second element labeled as “n.” This labeling convention means that the data structure may include any number of the elements. A second data structure, also labeled as “a” to “n,” may also include any number of elements. The number of elements of the first data structure and the number of elements of the second data structure may be the same or different.

While the invention has been described with respect to a limited number of embodiments, those of ordinary skill in the art, having the benefit of this disclosure, will appreciate that other embodiments can be devised that do not depart from the scope of the invention as disclosed herein. Accordingly, the scope of the embodiments described herein should be limited only by the appended claims.

What is claimed is:

1. A system comprising:
at least one processing device including a processor coupled to a memory;
the at least one processing device being configured to implement the following steps:
clustering health score vectors received from nodes operating in an environment, the health score vectors including feature health scores for sensors used by machine learning models;
comparing a model score distribution for an ensemble of the models with model score distributions per cluster, to obtain a set of top K performing models for each cluster;
upon receiving new data for prediction, identifying an associated health score vector for the data and using the top K performing models corresponding to the cluster for the associated health score vector to select the top K performing models; and
deploying the clusters and model ensembles to the nodes.

2. The system of claim 1, wherein the processor is further configured to implement the following steps:
causing the nodes to generate inferences using the deployed clusters and model ensembles to select a model among the top K performing models for generating the inferences.

3. The system of claim 1, wherein the model score distributions per cluster are obtained using steps comprising:
for each cluster,
determining a set of model score vectors per cluster, the model score vectors containing model scores, and
using the set of model vectors to construct the distributions of model scores per cluster.

4. The system of claim 3, wherein the model scores are determined by generating a vector for each model, the vector including feature importance scores for each feature of a corresponding model and the feature health scores for each feature of each sensor used by the corresponding model.

5. The system of claim 4, wherein the feature importance scores are arranged in a first matrix and the feature health scores are arranged in a second matrix, wherein each vector is a dot product of a corresponding first matrix and a corresponding second matrix, and wherein the vector includes a model score for each of the models.

6. The system of claim 1, wherein the model score distributions are constructed using distribution fitting.

7. The system of claim 1, wherein the model score distribution for the ensemble of the models is compared with the model score distributions per cluster using a probability distance measure.

8. The system of claim 1, wherein the feature health scores are collected according to a pre-determined period that is specified for each node.

9. The system of claim 1, wherein the health score vectors are received at a near edge node configured to accumulate the health score vectors prior to transmission to a central node.

10. The system of claim 1, wherein the clusters and model ensembles are reset periodically for re-clustering.

11. The system of claim 1, wherein the health score vectors are clustered using unsupervised multi-dimensional clustering.

12. The system of claim 1, wherein the health score vectors are clustered using supervised multi-dimensional clustering based on labels received from the nodes.

13. A method comprising:
clustering, by a central node, health score vectors received from nodes operating in an environment, the health score vectors including feature health scores for sensors used by machine learning models;
comparing, by the central node, a model score distribution for an ensemble of the models with model score distributions per cluster, to obtain a set of top K performing models for each cluster;
upon receiving new data for prediction, identifying, by the central node, an associated health score vector for the data and using, by the central node, the top K performing models corresponding to the cluster for the associated health score vector to select the top K performing models; and
deploying, by the central node, the clusters and model ensembles to the nodes.

14. The method of claim 13, further comprising causing the nodes to generate inferences using the deployed clusters and model ensembles to select a model among the top K performing models for generating the inferences.

15. The method of claim 13, wherein the model score distributions per cluster are obtained using steps comprising:
for each cluster,
determining a set of model score vectors per cluster, the model score vectors containing model scores, and
using the set of model vectors to construct the distributions of model scores per cluster.

16. The method of claim 15, wherein the model scores are determined by generating a vector for each model, the vector including feature importance scores for each feature of a corresponding model and the feature health scores for each feature of each sensor used by the corresponding model.

17. The method of claim 16, wherein the feature importance scores are arranged in a first matrix and the feature health scores are arranged in a second matrix, wherein each vector is a dot product of a corresponding first matrix and a corresponding second matrix, and wherein the vector includes a model score for each of the models.

18. The method of claim 13, wherein the health score vectors are received at a near edge node configured to accumulate the health score vectors prior to transmission to the central node.

19. The method of claim 13,
wherein the health score vectors are clustered using unsupervised multi-dimensional clustering, or
wherein the health score vectors are clustered using supervised multi-dimensional clustering based on labels received from the nodes.

20. A non-transitory processor-readable storage medium having stored thereon program code of one or more software programs, wherein the program code when executed by at least one processing device causes the at least one processing device to perform the following steps:
clustering health score vectors received from nodes operating in an environment, the health score vectors including feature health scores for sensors used by machine learning models;
comparing a model score distribution for an ensemble of the models with model score distributions per cluster, to obtain a set of top K performing models for each cluster;
upon receiving new data for prediction, identifying an associated health score vector for the data and using the top K performing models corresponding to the cluster for the associated health score vector to select the top K performing models; and
deploying the clusters and model ensembles to the nodes.
